(19) United States
(12) Patent Application Publication
(10) Pub. No.: US 2012/0011162 A1
(43) Pub. Date: Jan. 12, 2012

(54) COMPUTERIZED PORTFOLIO AND ASSESSMENT SYSTEM

(75) Inventors: GARY M. CHOBAN, Wexford, PA (US); David Choban, Cranberry Township, PA (US)

(73) Assignee: NUVENTIVE LLC, Pittsburgh, PA (US)

(21) Appl. No.: 13/153,864

(22) Filed: Jun. 6, 2011

Related U.S. Application Data
(63) Continuation of application No. 10/130,463, filed on May 17, 2002, now abandoned.
(60) Provisional application No. 60/250,342, filed on Nov. 30, 2000.

(51) Int. Cl. G06F 17/30

(52) U.S. Cl. 707/785; 707/E17.005

(57) ABSTRACT

A method that is operative with a computer executable code to create a selectively accessible and user controlled portfolio folder. The method, which is a computer implemented method for sharing personal information through an electronic communication network between a user and one or more reviewers, includes the steps of providing an electronic storage medium having a computer executable code for creating and viewing a selectively accessible electronic portfolio folder, establishing accounts for the users and the reviewers, allowing the user access to the computer executable code through the electronic communication network, allowing the user to create and/or edit one or more portfolio folders and place content in the portfolio folders, allowing the user to determine which reviewer may access the portfolio folders, allowing the one or more reviewers access to the computer executable code through the electronic communication network, and allowing the one or more reviewers to view the portfolio folders selected by the user.

### CROSS REFERENCE TO RELATED APPLICATION

This application is a continuation application and claims priority under 35 U.S.C. §119(e) to U.S. patent application Ser. No. 10/130,463, filed May 17, 2002, entitled, COMPUTERIZED PORTFOLIO AND ASSESSMENT SYSTEM, which application claims the benefit of U.S. Provisional Application Ser. No. 60/250,342, filed Nov. 30, 2000, entitled COMPUTERIZED PORTFOLIO AND ASSESSMENT SYSTEM.

### BACKGROUND OF THE INVENTION

1. Field of the Invention

This invention relates to a method of sharing information through an electronic communication network and, more specifically, to a method of sharing information in a portfolio folder wherein a user selectively allows access to the portfolio folder.

2. Background Information

Although seemingly a perennial topic of conversation by parents and politicians alike, our educational system has more recently emerged as one of the premier reformation projects of the new millennium. After nearly two decades of exploratory efforts to improve education, demands for measurable results and accountability are being heard from all segments in our society.

We are increasingly becoming a knowledge-based, rather than a labor-based economy. Companies are under pressure to find and retain skilled workers. Educational institutions are the cornerstone of this economy and are under increasing pressure to demonstrate their teaching effectiveness, and to fill this need for a knowledgeable workforce.

Educational institutions are being challenged to provide proof that they are fulfilling their educational and institutional objectives. This includes providing evidence of the effectiveness of teaching professionals, as well as validating that students are achieving the required levels of proficiencies and competencies. The school of the future will have to be able to demonstrate outcomes, modify its processes in real time to meet changing educational objectives and satisfy the learning needs of a student clientele who require an increasingly flexible and accountable educational system.

In turn, with their respective level of education completed, the burden of competence and accountability is then transferred to the student. The student must first exhibit sufficient proficiencies to be considered for the next transitional level, be it employment or educational, and then draw upon their educational investment to perform to expectations. It is therefore incumbent upon the student or parent to seek out the educational system or institution that can deliver the desired educational outcomes. As for the system or institution, it must prove it can provide the same.

In order to achieve these goals, educational institutions must engage in an on-going internal assessment program. In the successful assessment process, educational goals are translated into departmental objectives that are the basis for adopting choices in curriculum and teaching methods. Utilizing student performance data, measurement of progress against the objectives will validate whether, and to what extent, the choices were correct. This is important not only, because outcomes assessment is required for accreditation, but also to insure that the educational goals stated by the institution, are indeed being achieved.

Given the widespread acceptance of the assessment process as a powerful tool for positive change in education, one has to ask why the process isn't a robust part of the educational planning process in most institutions today. In fact, even though the process has been required for accreditation for colleges and universities for several years, “in a look at the assessment efforts for 320 institutions that went through North Central Association of Colleges and Schools accrediting process between 1997 and 1999, Associate Director Cecelia Lopez found that virtually all institutions were either just starting various aspects of their assessment programs or had only some implementation to speak of Only a small minority of institutions made full use of the assessments in their educational planning and practices.”

However, understanding the culture of academia, some of the problems are easily seen. In the case of the Commission of Institutions of Higher Education, which requires an assessment program for accreditation, the Commission does not prescribe a specific methodology of assessment. Instead, it “calls on each institution to structure an assessment program around its stated mission and educational purposes.” Although institutions have freedom in developing their own assessment methodologies, the lack of prescribed structure and process presents significant challenges. Add to this the abstract concept of assessment, and the inherent challenge in translating “educational goals and purposes” into measurable learning objectives as part of the assessment process. The difficult nature of the assessment task coupled with the lack of dedicated time for assessment on the part of both faculty and students have significantly impeded the adoption of an effective assessment process. One can almost imagine hearing the groaning of teaching professionals and students nationwide realizing that they must assume the burden of a process that is usually unclear and which they are certain they do not have the time to complete. Clearly the assessment process needs to be structured, quick and easy to use or it is likely to fail.

With respect to students, they will be increasingly challenged to demonstrate proficiencies and competencies for both educational and employment objectives. This will require an electronic means of relaying complex information in a flexible and secure manner to a variety of audiences.

Presently, information may be shared through an electronic communication network, such as the Internet. However, a user must either post the information for general access, e.g. by creating a web page, or must directly communicate with the intended party, e.g. an e-mail message. There is not presently a method that allows a user to control who may access the content posted by the user. For example, a resume service may allow a user to upload their resume. But, after the resume is uploaded, the user has no control over who views the resume. This limits the job seeker's options if he or she is currently employed and does not wish their current employer to know that they are seeking employment.

There is, therefore, a need for a method of sharing information over an electronic communication network that allows the user to select who may view the information.

There is a further need for a computer implemented method of sharing information over an electronic communication network that allows the user to select who may view the information.

There is a further need for a computerized network for creating and providing access to a portfolio that includes, a first computer having a memory means for storing a portfolio, the portfolio including means for the user to control selective access by others to information in the portfolio, and, a second computer in electronic communication with the first computer, the second computer accessing the information in the portfolio to which the user has permitted access.

There is a further need for a method of creating and providing access to a computerized portfolio that includes the steps of, providing a computer having computer software to guide a user in entering information related to the computerized portfolio into said computer, entering the information into the computer, and permitting other computers to have selective electronic access to the information in said portfolio, the selective electronic access being controlled by the user.

### SUMMARY OF THE INVENTION

These needs, and others, are met by the disclosed invention which provides for a method that is operative with a computer executable code to create a selectively accessible and user controlled portfolio folder. The method, which is a computer implemented method for sharing personal information through an electronic communication network between a user and one or more reviewers, includes the steps of: providing an electronic storage medium having a computer executable code for creating and viewing a selectively accessible electronic portfolio folder,

establishing accounts for the users and the reviewers, allowing the user access to the computer executable code through the electronic communication network, allowing the user to create and/or edit one or more portfolio folders and place content in the portfolio folders, allowing the user to determine which reviewer may access the portfolio folders, allowing the one or more reviewers access to the computer executable code through the electronic communication network, and allowing the one or more reviewers to view the portfolio folders selected by the user.

The disclosed invention also provides for a computerized network for creating and providing access to a portfolio folder that includes a first computer having a memory means for a computer executable code and for storing a portfolio folder, the computer executable code including means for the user to control selective access by others to information in the portfolio folder, and a second computer in electronic communication with the first computer, the second computer accessing the information in the portfolio folder to which the user has permitted access.

The disclosed invention also provides for a method of creating and providing access to a computerized portfolio folder that includes the steps of providing a computer having computer software to guide a user in entering information related to the computerized portfolio folder into the computer, entering the information into the computer, and permitting other computers to have selective electronic access to the information in the portfolio folder, the selective electronic access being controlled by the user.

The disclosed invention also provides for an assessment process that includes the steps of providing a computer software program that manages the assessment process and providing at least one computerized portfolio folder, wherein the program and the computerized portfolio are linked such that such program can selectively access and download items from the computerized portfolio folder into the computer program so that the computer program can manage the assessment.

The disclosed invention also provides for a communication system that includes, a first computer used by a user and in communication with an electronic communications network, a second computer used by a reviewer and in communication with an electronic communications network, a server having a computer readable medium and in communication with an electronic communications network, the first computer in communication with the server through the electronic communications network, the second computer in communication with the server through the electronic communications network, and, a computer executable code stored on the computer readable medium wherein the server is operative with the computer executable code to create a selectively accessible and user controlled portfolio folder.

The disclosed invention also provides for an HTML page generated by a server have a computer executable code, the HTML page presenting information soliciting responses from a user, the responses communicated to the computer executable code so that the computer executable code performs operative steps for creating and viewing a selectively accessible electronic portfolio folder, establishing accounts for the users and the reviewers, allowing the user access to the computer executable code through the electronic communication network, allowing the user to create and/or edit one or more portfolio folders and place content in the portfolio folders, allowing the user to determine which reviewer may access the portfolio folders, allowing the one or more reviewers access to the computer executable code through the electronic communication network, and allowing the one or more reviewers to view the portfolio folders selected by the user.

### BRIEF DESCRIPTION OF THE DRAWINGS

A full understanding of the invention can be gained from the following description of the preferred embodiments when read in conjunction with the accompanying drawings in which:

FIG. 1 is a schematic view of the communication system.

FIG. 2 is a flow chart showing the primary steps of the method.

FIG. 3 is a screen shot showing an input screen for information.

FIG. 4 is a screen shot showing an input screen for selecting reviewers allowed to access a portfolio folder.

FIG. 5 is a schematic diagram of the initial steps of the method.

FIG. 6 is a schematic diagram of the secondary steps of the method.

FIG. 7 is a schematic diagram of the steps associated with building a profile.

FIG. 8 is a schematic diagram of the steps associated with editing a profile.

FIG. 9 is a schematic diagram of the steps associated with building a portfolio folder.

FIG. 10 is a schematic diagram of the steps associated with adding content to a portfolio folder.

FIG. 11 is a schematic diagram of the steps associated with editing a profile.

FIG. 12 is a schematic diagram of the steps associated with managing a master portfolio.

FIG. 13 is a schematic diagram of the steps associated with reviewing a portfolio folder.

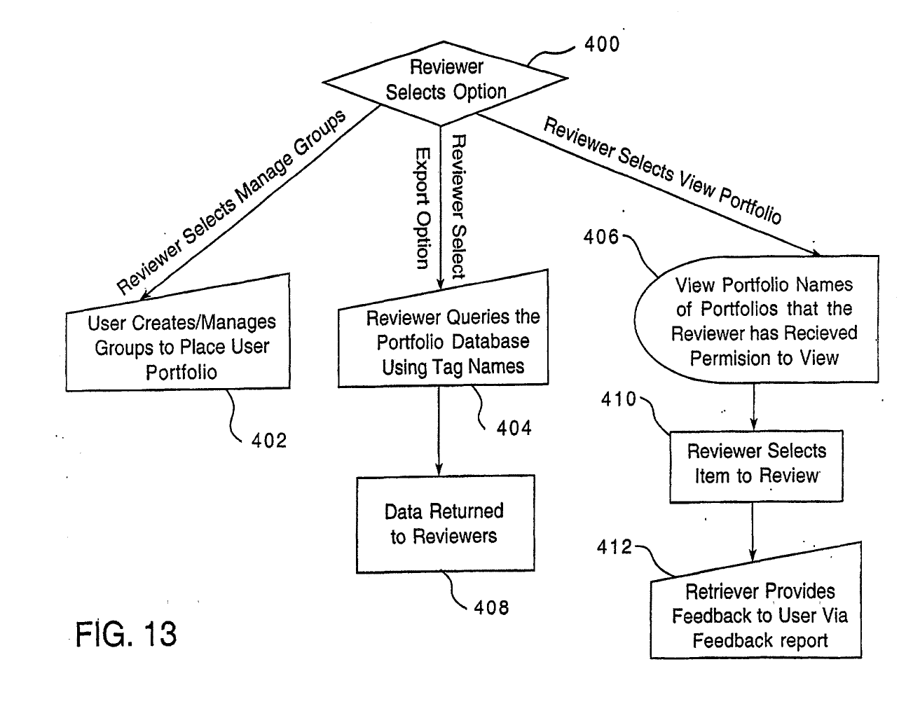

### DESCRIPTION OF THE PREFERRED EMBODIMENTS

The method includes an Internet-based computer executable code for students to accumulate, exhibit, and grant access and control to samples of proficiency in curriculum or professional requirements. An assessment program application provides a template for implementing and managing the entire educational “assessment process” which is required of colleges and universities for accreditation purposes. The computer executable code establishes a standardized methodology for students to do “self-assessment” and for creating, storing, and accessing personalized presentations of the student's work and skills. Using “wizard” style tools, the student are able to easily manage audio, video, text, and other file format s, exhibiting anything from writing samples to test scores to software programming samples. These samples can then be stored in various “portfolio folders” which can be arranged to create custom presentations for specific uses for which access can be selectively granted and controlled by the student. Some examples of these uses might be curricular assessment, graduate school application, employment placement, or providing work samples for institutional assessment (the latter automatically interfaces with the assessment software). A robust security model allows the student to dynamically control access to their portfolio folders. This access ranges from single requester, to defined groupings of requesters, to access resulting from a match of a web search. The computer executable code allows an individual to dynamically control what information about themselves they want to share, when to share it, and with whom they want to share it.

Although capable of being a stand-alone application, the computer executable code is structured to work with the assessment software. We expect rapid and widespread adoption of the computer executable code in schools using such assessment software as it meets a critical need for both institutions and students. In fact, based on discussion with existing assessment software clients we anticipate a significant number of schools will mandate the use of the computer executable code. This relationship between the two applications allows for the rapid growth of an installed base of student users as described below in the “Distribution/Sales” section.

The computer executable code allows students and institutions to derive value from the capability of easy and systematic access to curriculum data and exhibits of proficiency by the students in a secure environment. The computer executable code provides three immediate avenues of benefit to students and institutions. These are:

Student Self-Assessment—Many schools and departments already require students to utilize portfolios for this purpose. However, in all cases it is either a paper copy of the students work or the student creates a web page. This makes utilization of the information difficult. Additionally, students are often left with the question of “how to do it.” The computer executable code provides students with a clear framework for managing their work samples, journaling their learning experiences, providing information to their school for assessment, providing detailed information for employment, etc. In the traditional model and usage of the computer executable code, students often lose access to the very data they collect when it becomes the most beneficial, specifically when student are pursuing employment after graduation or presenting information for admittance to graduate school. Since the computer executable code will be student owned and controlled this would eliminate this problem.

Job Placement—the computer executable code provides student with a “professional” portfolio of work samples for employment purposes that is far more robust than a simple resume. Many students have little or no work experience and few exhibits of accomplishments and competency. This makes it difficult for employers to verify credentials. The computer executable code enables a student to provide adequate evidence of skills and proficiencies to future employers. In addition, the computer executable code allows students to “tag” their portfolios with key words. Prospective employers searching for candidates that meet certain criteria can then use these key words. For example, based on some key words “tagged” by the user, prospective employers could search for all Computer Science majors, with a GPA greater than 3.7 that have web development skills. Since institutional success is often judged on successful job placement of students, the computer executable code also helps educational institutions realize their goal.

Institutional Recruiting—Similar to an employer hiring an employee, educational institutions have the same burden of searching for the best potential students. As the computer executable code proliferates to K-12, student will maintain a collection of work to provide electronically to institutions as evidence of learning. This will provide the admission offices with more data on prospective students as well as help reach a new market of student beyond the geographical recruiting region.

The user has the ability to store a series of electronic files, and via templates create different portfolio views. The different templates include, but are not limited to, Self-Assessment, School Application, Employment and Other (used for customized views).

Now, as students gather portfolio items and relate them to a portfolio folder accessible by the assessment software, the institution automatically has their portfolio assessment data entered into the assessment software. At the same time, the student has the ability to create other portfolios for personal purposes such as job placement and can selectively control access to each portfolio.

The computer executable code, by design, is a storage receptacle for any number and types of electronic or computer files reflecting exhibits of a student's work. These electronic files may consist of item such as tests, samples of writing, or any other such educational measurement exhibit that can be stored as an electronic file. Collectively, these items are used as measurement data with regard to student performance. The computer executable code, however, is not limited to application in the educational field, but can also be used for assessment in hospitals and businesses.

In accordance with the invention, assessment software and the computer executable code are linked such that the assessment software program can selectively access and download items from the computer executable code so that the assessment software can use the items as measurement data in the assessment process. This selective accessing and downloading provides an automated and flexible method to allow assessment evaluators to sample items from the computerized portfolios. The selective accessing and downloading is accomplished, preferably, by using a rule-based engine.

For example, in the educational setting, students input into the computer executable code papers and/or projects to document their own personal education experience. The assessment software rules based engine can be used by assessment evaluators, such as school administrators, to go out into the population of the portfolio folders which permission has been granted by the user and selectively access, for example, 10% of the freshman final compositions, which are part of all of the student portfolios. In this way, the selection process is automated and flexible, and allows the assessment evaluators to gather data without the need to directly collect this data from the students.

As used herein, a “computer” includes devices associated with a computer which are coupled to a CPU, such as keyboards and mice, displays or other components for interacting with humans, as well as computers such a server which is typically accessed from a remote location.

As used herein, “computer executable code” includes, but is not limited to, a computer program or a group of interacting programs used by a processor and stored on a medium such as a hard drive, CD, DVD, or in an integrated circuit such as an EPROM.

As used herein an “electronic communication network” includes any system of linked computers such as the Internet, an Intranet, or a school or company network.

As used herein an “computer readable medium” includes, but is not limited to, hard drives, CDs, DVDs, magnetic tape, floppy drives, and random access memory.

As used herein a “computer file” is an electronic storage means for containing data that may be expressed as text, images, audio, video or any combination thereof.

As used herein, “associate [-d], [-ing]” when used in to describe an action by a computer, e.g. “associating computer files with portfolio folders,” means that the computer file is linked to, or may be accessed by, the portfolio folder.

As used herein, a “page” means a static or interactive HTML screen that is displayed on a computer monitor.

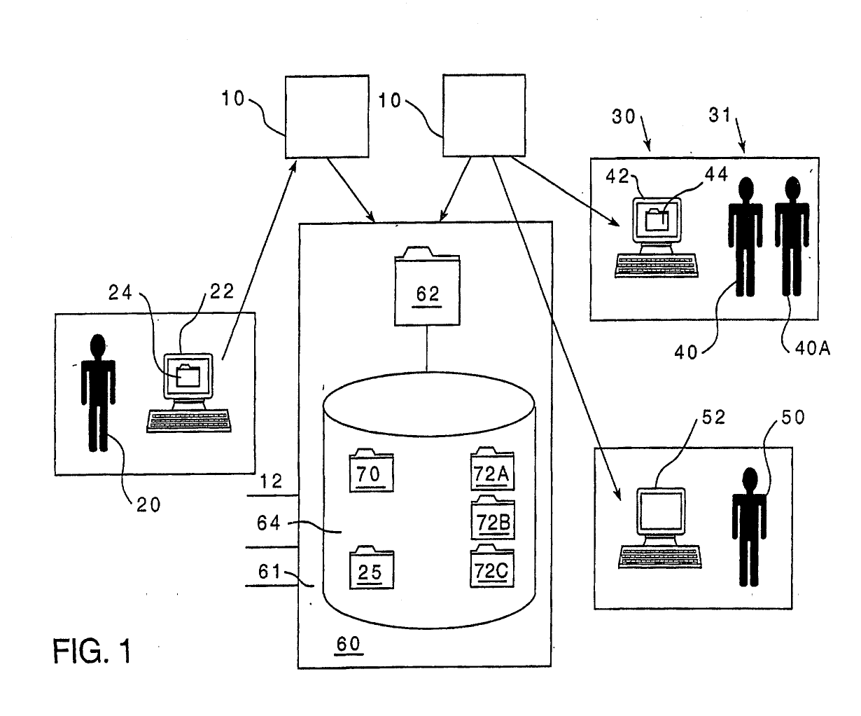

As shown on FIG. 1, a communication system 1 and method for sharing personal information utilizes an electronic communication network 10 that is structured to allow communication between a user 20 and one or more reviewers 30 via a computer executable code 60. The computer executable code 60 is operational on a server 12 or remote computer. The user 20 has a first computer 22 which is coupled by a modem (not shown) or other communication device to the electronic communication network 10. The user 20 may input information into the first computer 22 to create computer files 24. Additionally computer files 24 may be created on a separate computer and transferred to the first computer 22 or the user 20 may use the first computer to interact with the computer executable code 60 to create computer files 24. There are two types of reviewers 30, a feedback reviewer 40 and a observer reviewer 50. As will be described below, a feedback reviewer 40 is able to input information, in the form of feedback reports 44, into the computer executable code 60. The feedback reviewer 40 has a second computer 42 which is coupled by a modem (not shown) or other communication device to the electronic communication network 10. The feedback reviewer 40 may input information into the second computer 42 to create feedback reports 44. The observer reviewer 50 has third computer 52 which is coupled by a modem (not shown) or other communication device to the electronic communication network 10. Each user 20 and reviewer 30 will have an account that is tracked by the computer executable code 60.

The computer executable code 60 is stored on a computer readable medium 61 and includes both the operating code 62, which is structured to interact with the user 20 and reviewers 30, and the stored computer files 64. The operating code 62 is structured to perform the steps detailed below. The stored computer files 64 includes user computer files 24 and feedback reports 44, as well as additional computer files 24 created by the operating code 62 to manage the user computer files 24 and feedback reports 44, track the user and reviewer accounts, and other functions as described below.

The computer executable code 60 is structured to receive the user computer files 24 through the electronic communication network 10 and place the user computer files 24 into the storage medium 64. The entirety of the user computer files 24 forms the master portfolio 70. The computer executable code 60 is structured to request information regarding each said computer file 24 placed in the storage medium 64. This information is input via input fields 153 (described below) that include descriptions. That is, the computer executable code 60 has a limited number of choices for certain input fields 153. These limited choices are used to create file tags 25 which act as an identification and tracking means. For example, one input field 153 may request that the user identify his or her occupation from a list. Each listed occupation has an electronic tag 25 associated with the occupation. Thus, the computer executable code 60 may easily sort and index the information based on the tags 25. The computer executable code 60 then allows the user 20 to select individual user computer files 24 to be associated with one or more portfolio folders 72A, 72B, 72C. The computer executable code 60 also tracks and indexes the reviewers 30. The computer executable code 60 may place the reviewers 30 in a group 31 based on a common characteristic. The computer executable code 60 provides a list of the reviewers 30 or groups of reviewers 31 to the user 20 and allows the user to select which reviewers 30 or groups of reviewers 31 may access the individual portfolio folders 72A, 72B, 72C. After the portfolio folders 72A, 72B, 72C are created and access authorized by the user 20, the computer executable code 60 is structured to allow the reviewers 30 or groups of reviewers 31 to access and view the individual portfolio folders 72A, 72B, 72C through the electronic communication network 10.

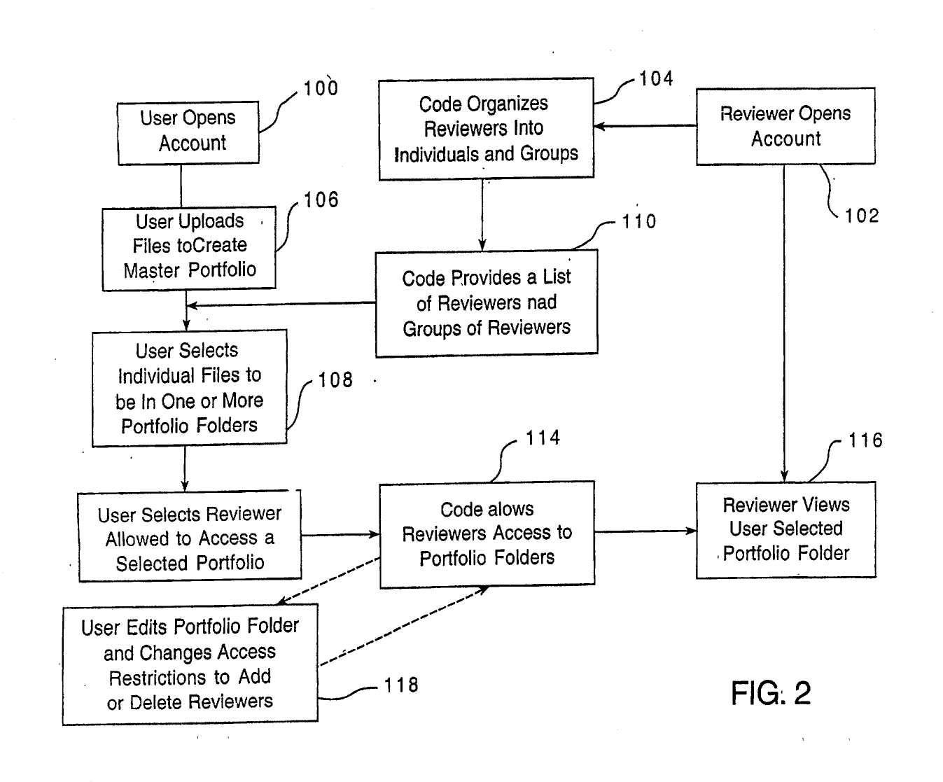

Thus, as shown on FIG. 2, the method which is implemented by a computer includes the steps of the user 20 opening an account 100. One or more reviewers 30 opening an account 102. When a reviewer 30 or group of reviewers 31, e.g. a school, opens an account, the computer executable code 60 identifies and organizes the group 31 by an affiliation code 104. The computer executable code 60 then allows the user 20 to upload a plurality of computer files 24 thereby creating 106 a master portfolio 70. The computer executable code 60 then allows the user 20 to select 108 individual computer files 24 to be in selected portfolio folders 72A, 72B, 72C. The computer executable code 60 provides 110 a global list of all the reviewers 30 or groups of reviewers 31 to the user 20. The computer executable code 60 then allows the user 20 to select 112 which reviewers 30 or groups of reviewers 31 may access the selected portfolio folders 72A, 72B, 72C. Based on input from the user 20, the computer executable code 60 then allows the selected reviewers 30 or groups of reviewers 31 to access 114 the selected portfolio folders 72A, 72B, 72C. The reviewers 30 or groups of reviewers 31 may then view 116 the selected portfolio folders 72A, 72B, 72C. After the initial portfolio folders 72A, 72B, 72C are created, the computer executable code 60 allows the user 20 to edit 118 the portfolio folders 72A, 72B, 72C or change which reviewers 30 or groups of reviewers 31 may access the portfolio folders 72A, 72B, 72C.

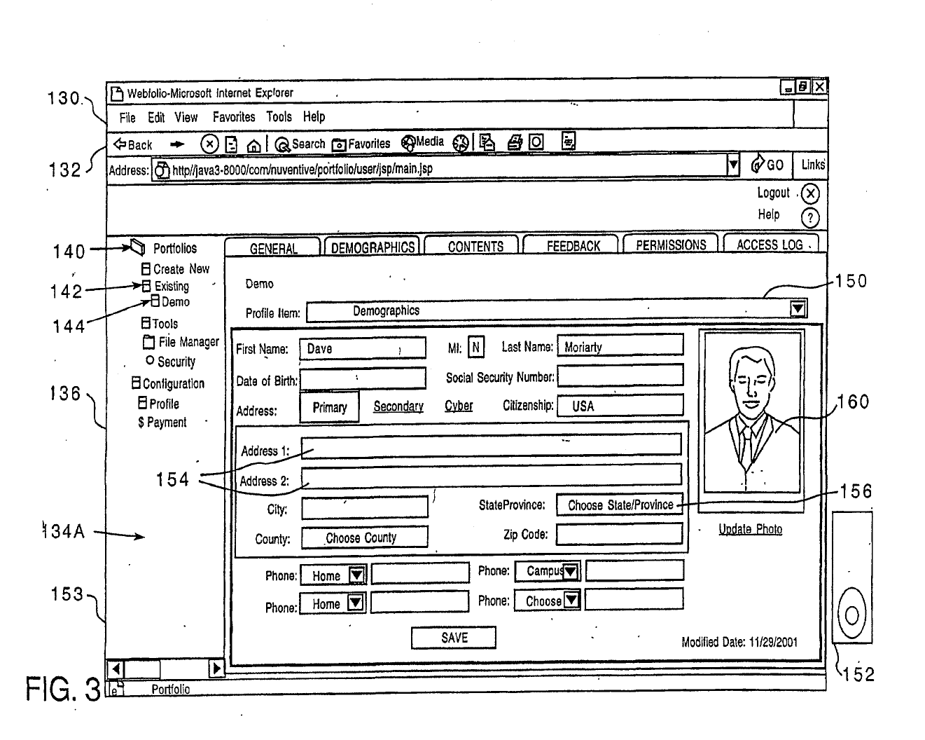

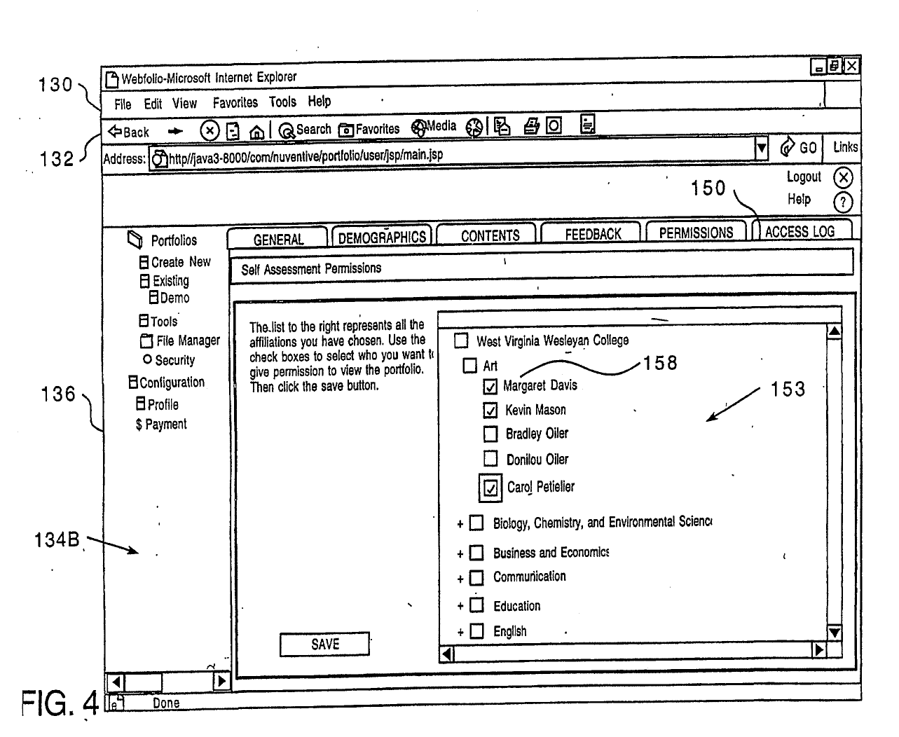

The user 20 and reviewers 30 interact with the computer executable code 60 using a computer 22, 42, 52 in conjunction with the electronic communication network 10. Typically, such interaction will occur using a web browser. That is, a computer executable code that is structured to interpret and present a HTML page. FIGS. 3 and 4 are screen shots showing a typical web browser that is connected with the computer executable code 60. The web browser includes a tool bar menu 130 and tool bar buttons 132 that may be used to navigate HTML pages and operate web browser. These 130, 132 elements are part of the web browser computer executable code. Below the tool bar menu 130 and tool bar buttons 132 is the HTML page 134A, 134B representing the computer executable code 60. The HTML page 134A, 134B includes a primary menu 136. The primary menu 136 may have a plurality of options each with a plurality of levels, such as a first level menu 140, a second level menu 142, and a third level menu 144. As is known, a menu may only display the first level menu 140 until a user 20 uses an input device, such as a mouse, to select an option on the menu whereupon the one or more sub-levels 142, 144 of the menu are displayed. Additionally, there may be a secondary menu 150 allowing access to options not shown in the primary menu 136. Information is displayed on the HTML page 134A, 134B as text, still images and video images. Additionally, audio information may be played through a speaker 152.

The user 20 utilizes the first computer 22 to interact with the computer executable code 60 to create certain computer files 24. These computer files 24 are created by the user 20 entering information into input fields 153 such as a text box 154 (FIG. 3), an option box 156 (FIG. 3) which then provides a selection for the user 20, or a choice box 158 (FIG. 4) that either activates or deactivates a certain choice. The types of computer files 24 created are discussed in detail below. Additional computer files 24, such as a picture 160, may be uploaded to the storage medium 64.

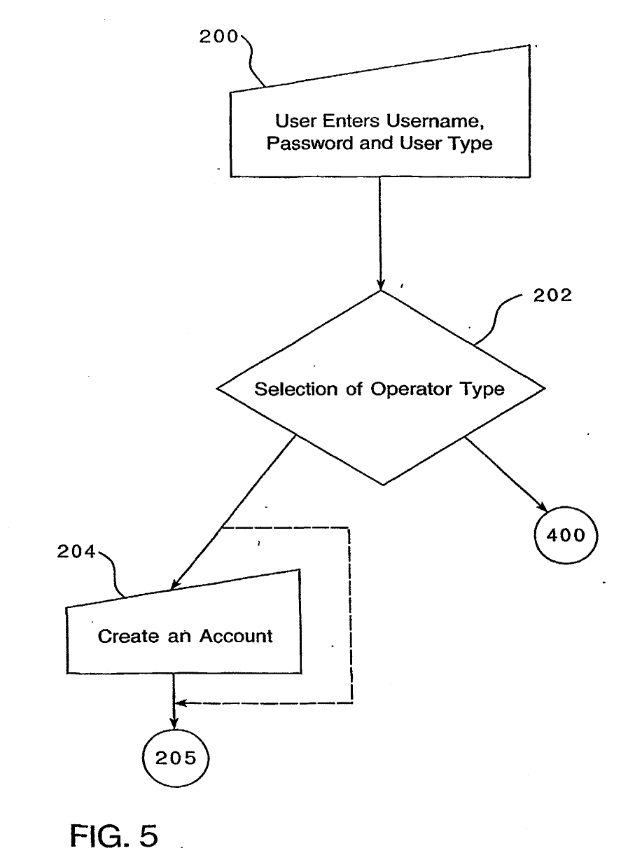

The disclosed method operates by allowing the user 20 and the reviewers 30 to interact with the computer executable code 60 via the menus 136, 150 and the input fields 153. The method may be used in many situations, e.g. engineers sharing ideas, with reviews by supervisors and salespersons. However, as used herein, the user 20 will be a student, the feedback reviewers 40 will be the student's teachers and the observer reviewers 50 will be potential employers. Initially, as shown schematically on FIG. 5, the computer executable code 60 allows the student user 20, or reviewer 30 as described below, to access a first page which includes a means, such as a text box 154, for the user 20 or reviewer 30 to log on 200 to the system by entering a name and/or a password that allows further access to the computer executable code 60. If the name and/or password is not encoded with the type of operator, i.e. student user 20 or reviewer 30, a second page will allow the selection 202 of the type of operator. This selection 202 may only have to be done one time, when the operator sets up his or her account. For example, if it is a student user's first time accessing the system, the computer executable code 60 will provide a temporary user name and password. The computer executable code 60 then prompts the student user 20, by various input fields 153, to set up an account 204 by inputting initial personal information such as name, address, telephone number as well as a payment method. Where the user 20 is a student, the payment method may be a code supplied by the student's school which has previously purchased a bulk license. The payment method could be any other common means such as a credit card. Once this information is associated with the account, the information does not have to be input again. By entering 200 a name and password, the computer executable code will access the file with the profile data and thus recognize the user 20 or reviewer 30. At this point the student user 20 may select a user name and a password. The student user 20 will only be required to enter this information one time. After the student user 20 enters this information the computer executable code 60 creates a profile computer file 24 that is stored in the storage medium 64. At this point the student user 20 is logged in and the computer executable code 60 presents 205 the student user 20 with an initial first level menu 140.

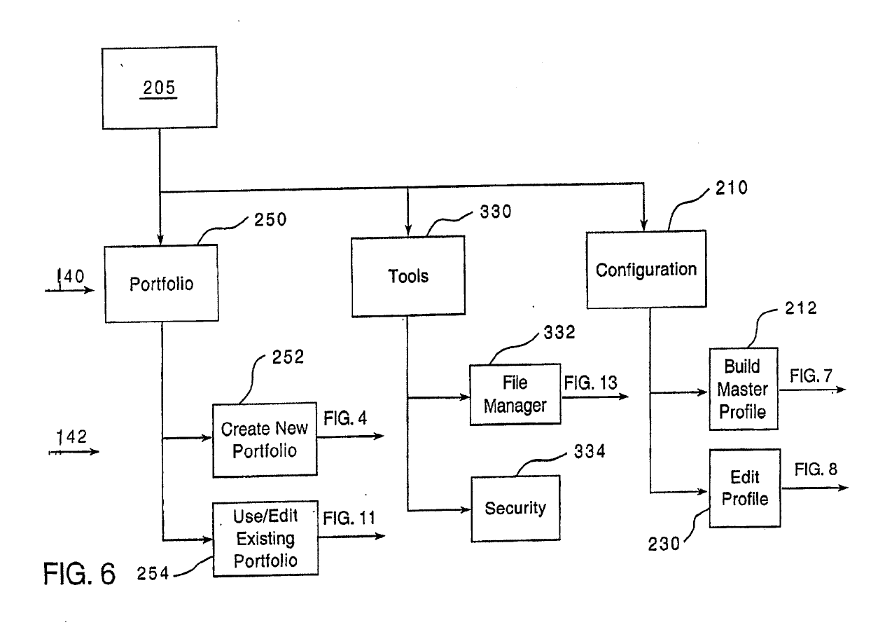

The initial first level menu 140 is shown schematically on FIG. 6. The first level menu 140 presents options in the menu/sub-menu format. Through the initial first level menu 140 the computer executable code allows the student user 20 to select from the options; portfolio 250, tools 330, and configuration 210. The second level menu under configuration includes the options to build a master profile 212 and edit profile 230.

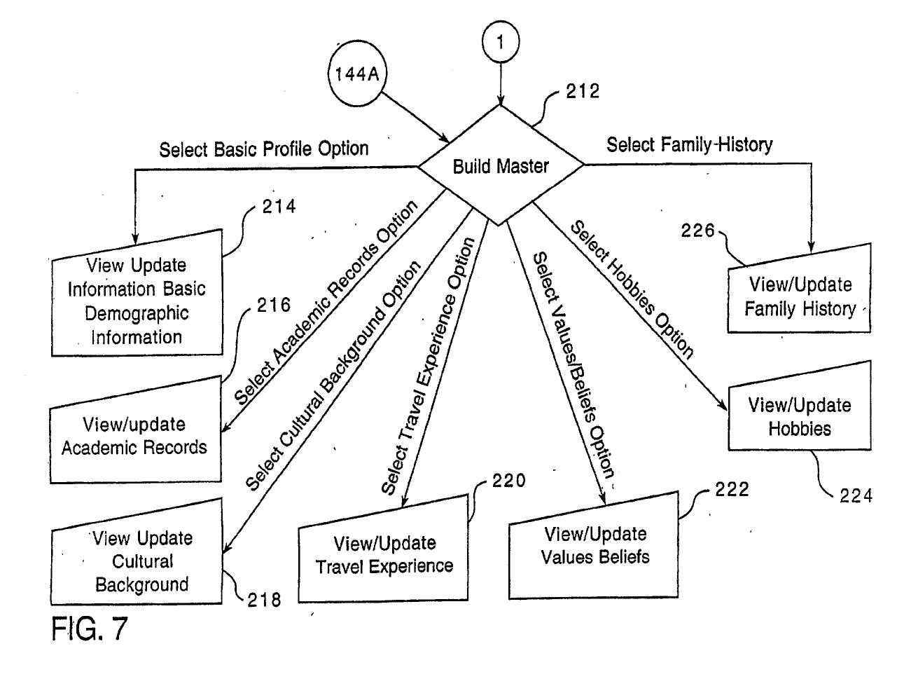

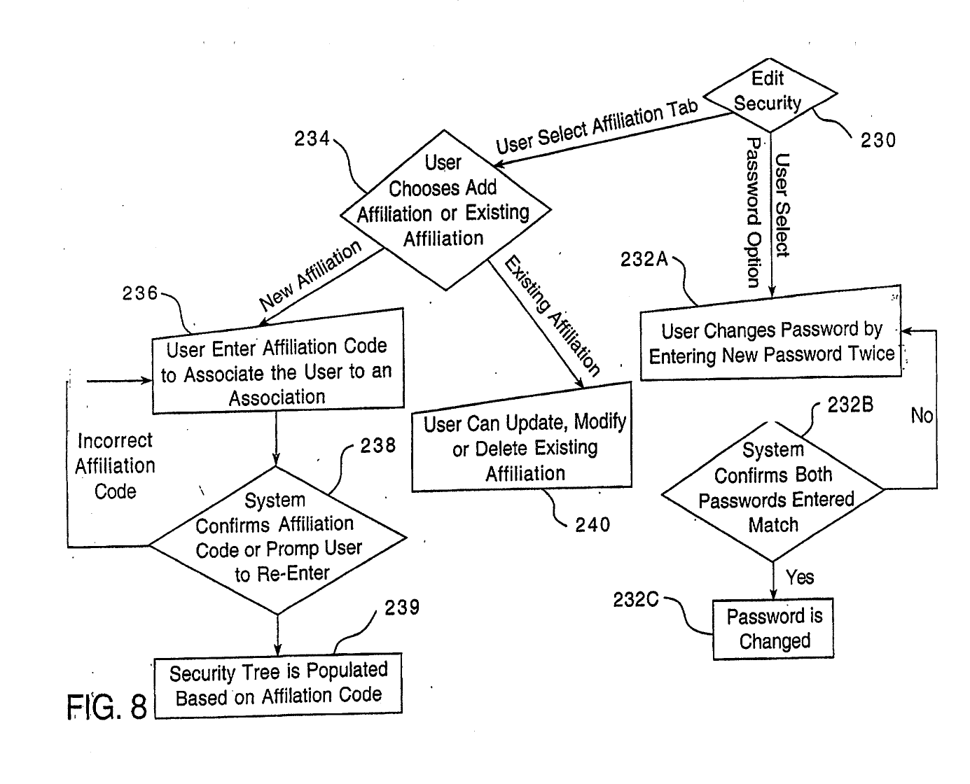

After selecting to build a master profile 212, the student user is presented with a third level menu 144A for building a master profile as shown schematically on FIG. 7. A master profile may include many forms of information, however, for this example the options for building a master profile 212 allow the student user 20 to: view/edit basic demographic information 214, view/edit academic records 216, view/edit cultural background 218, view/edit travel experience 220, view/edit values and beliefs 222, view/edit hobbies 224, and view/edit family history 226. When the student user 20 selects one of the options from the build a master profile third level menu 144A he or she will be prompted by various input fields 153 to enter information. For example, when the student user 20 selects view/edit basic demographic information 214, he or she will see and be able to edit information regarding his or her address, telephone number, grade level or other basic demographic data. The computer executable code 60 attaches tags 25 to this data as explained above. When the student user 20 selects view/edit academic records 216, he or she will see and be able to edit information regarding his or her academic records such as transcripts, class standing, or majors and minors. The student user 20 may also upload any computer files 24, e.g. documents or multimedia files. This creates the content for the master portfolio 70. When the student user 20 selects view/edit cultural background 218, he or she will see and be able to edit information regarding his or her ethnicity, religion or national origin. When the student user 20 selects view/edit travel experience 220, he or she will see and be able to edit information regarding his or her travel experience and like or dislike of travel. When the student user 20 selects view/edit values and beliefs 222, he or she will see and be able to edit information regarding his or her political affiliations or causes he or she has supported. When the student user 20 selects view/edit hobbies 224, he or she will see and be able to edit information regarding his or her hobbies and activities. When the student user 20 selects view/edit family history 226, he or she will see and be able to edit information regarding his or her family and their history. Each one of these entries becomes a computer file 24 or part of a computer file 24. As shown on FIG. 8, after allowing the student user 20 to select the configuration option 210, the computer executable code 60 also allows the student user to select the edit profile option 230. The computer executable code 60 then presents the student user 20 options that allow the user to change the password 232 or to change an affiliation 234 (described below). For example, to change a password, the computer executable code 60 allows the student user to enter a new password 232A. The computer executable code 60 then confirms 232B the new password before changing the password 232C.

Any user of the computer executable code 60 has access to a global list of reviewers 30. This list, however, is populated with a top level list of reviewers. That is, the top list typically shows a single check box 158 for each organization that uses the computer executable code 60. For example, State University and State Institute of Technology would each have a check box 158. The user 20, however, can not access the individuals affiliated with the organization until an affiliation code is used. An affiliation code is assigned to each predefined set of reviewers 30. For example, all the teachers at a school may be an affiliation. The school provides the affiliation code to each student user 20. The computer executable code 60 allows the student user 20 to enter a code 236, confirms the code 238, and then allows the student user 20 to seen the entire list of reviewers within an affiliation. Thus, after the student user 20 enters 236 the affiliation code for State University, the check box 158 on the global reviewer list becomes a hierarchy tree of check boxes 158, as detailed below. The affiliation code for each student user 20 is stored in the computer executable code 60 and controls the presentation of information, e.g. the student user 20 will have access to global templates, which are available to all users 20, and to templates created by teacher reviewers 40 affiliated with the school.

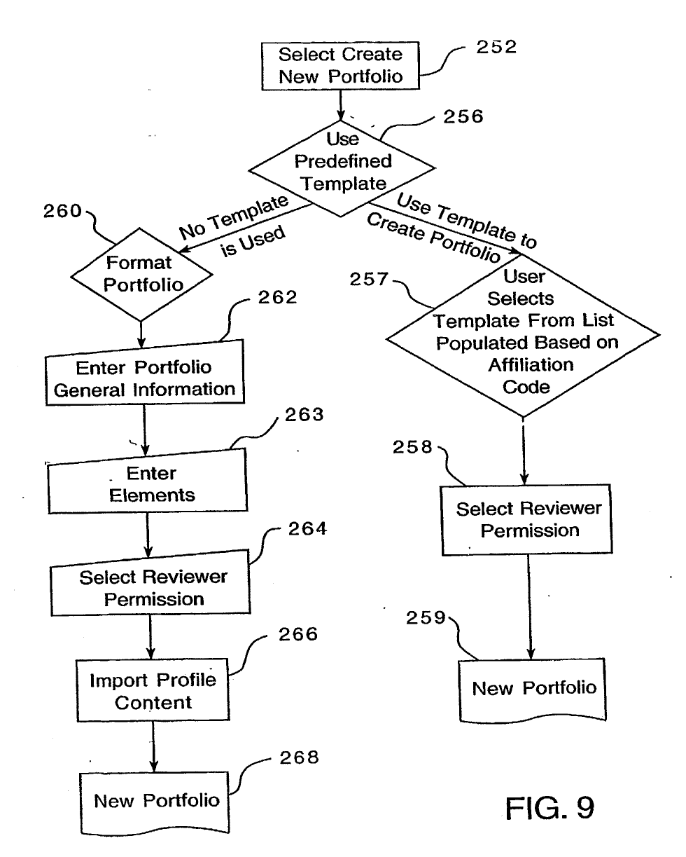

As shown on FIG. 6, the computer executable code 60 also allows the student user 20 to select the portfolio option 250 from the first level menu 140. When the portfolio option is selected 250, the computer executable code 60 allows the student user 20 select the options: create a new portfolio 252 or edit an existing portfolio 254. As shown on FIG. 9, when the student user 20 selects create a new portfolio 252 the computer executable code 60 initially allows the student user 20 to use pre-defined template 256 to create a portfolio folder 72A. A template may be created, for example, by a teacher reviewer 40 and stored with the computer executable code 60. As will be described below, the computer executable code 60 allows the user to include certain elements 270 such as objectives 278 and goals 280, e.g. write three short stories, in the portfolio folder 72A. By creating a template, a teacher reviewer 40 may ensure that each student user 20 in the class has the same number of objectives 278 and goals 280. Additionally, a template will include predefined tags 25 for each element 270. The computer executable code 60 allows the student user to select 257 a template from a list of global templates, which are available to all users 20, or from a list of templates from the affiliated school. After the student user selects 257 the template to be used, the computer executable code 60 allows the student user to select 258 which reviewers 30 may have access to the portfolio folder 72A. The selection 258 of reviewers is detailed below. Additionally, the computer executable code 60 will import general demographic data from the user's profile, e.g. an address, into the portfolio folder 72A. After the template is selected 257, and the permissions granted 258, the portfolio folder 72A is created 259.

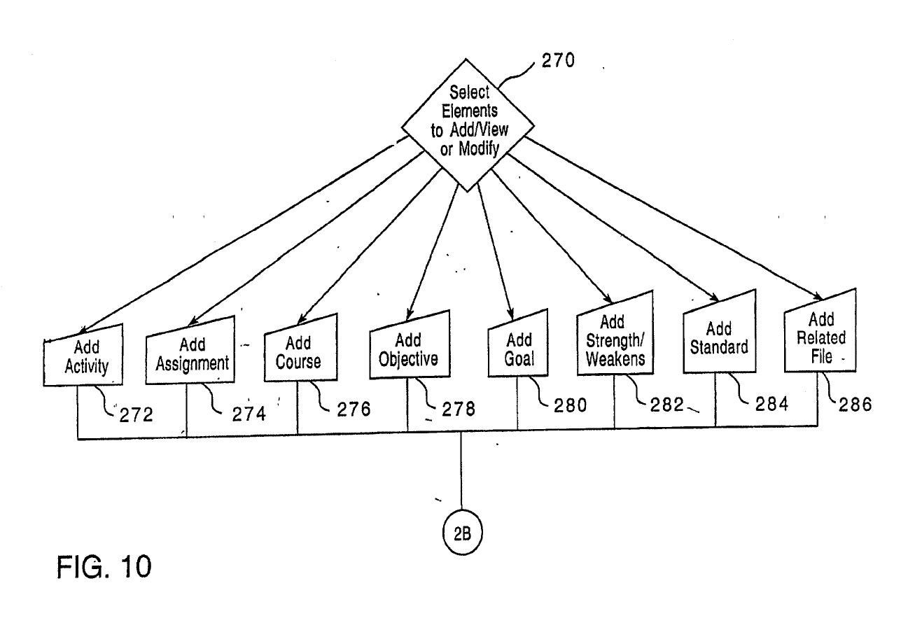

If a template is not used, the computer executable code 60 allows the student user to format 260 the portfolio folder 72A. Initially, the computer executable code 60 allows the student user 20 to input general information 268 regarding the portfolio folder, e.g. a name for the portfolio folder 72A. Additionally, the computer executable code 60 will import general demographic data from the user's profile, e.g. an address, into the portfolio folder 72A. The computer executable code 60 then allows the student user 20 to add any number of content elements 270 to the portfolio folder 72A. As shown on FIG. 10, the computer executable code 60 is structured to allow the student user 20 to add an activity 272, add an assignment 274, add a course 276, add an objective 278, add a goal 280, add a strength/weakness 282, add a standard 284 or add a content file 286. The elements 270 are entered through various input fields 153. For example, a goal may be typed into a text box 154. These elements 270 are selected based on the intended use of the portfolio folder 72A. For example, a portfolio folder 72A intended to be reviewed by a teacher reviewer 40 may include elements 270 such as a number of assignments, the goals associated with each assignment and the strength/weakness element. Thus, the teacher reviewer 40 can compare the assignment to the intended goal and comment on any improvement regarding the strength/weakness of the student user 20. Conversely, a portfolio folder 72A intended to be reviewed by a prospective employer 50 may include a report and related files, such as back up material, so that the employer may see the basis of the student user's 20 report.

The computer executable code 60 then allows the student user 20 to select 264 which reviewers 30 may have access to the portfolio folder 72A. The computer executable code 60 includes a global list of all possible reviewers 30, however, as explained above, each account may only have access to certain individual reviewers 30 affiliated with the student user 20. For example, the student user 20 will have an account that limits the reviewers 30 available to teacher reviewers 40 at his or her school based on the affiliation code which was previously entered. As such, the computer executable code 60 presents the student user with a limited list of individual reviewers 30. As shown on FIG. 4, the computer executable code 60 presents the reviewers 30 as an expandable hierarchy of choice boxes 158. For example, the student user may check the highest level choice box 158, as shown, the entire school, or the user may expand the hierarchy to show the departments within the school. Here, the computer executable code 60 allows the student user 20 to grant access to an entire department by checking the choice box 158 for the department. Alternatively, the computer executable code 60 allows the student user to expand the hierarchy again to show individual teacher reviewers 40 within each department. The computer executable code 60 allows the student user 20 to grant access to a specific teacher reviewer 40 by checking the appropriate choice box 158. As is known in the art, if an upper level of the hierarchy is selected, all selections below that selection in the hierarchy will also be selected. This type of hierarchy may be used with regard to employers or other groups as well. That is, as opposed to a hierarchy of school/department/teacher, an employer hierarchy may be occupation/geographic region/company.

To finish the creation 268 of the portfolio folder 72A, the computer executable code 60 allows the student user 20 to select 266 one or more computer files 24 from the master portfolio 70 to be associated with the portfolio folder 72A. The computer executable code 60 presents a list of all the tagged and stored files 64 along with an input field 153, such as a check box 158. By selecting a stored file 64, the stored file 68 becomes associated with the portfolio folder 72A. Once the general portfolio folder information is selected 262, portfolio elements are entered 263, the reviewer permissions are selected 264, and the content associated 266 with the portfolio folder 72A, the portfolio folder 72A is completed and stored 268 by the computer executable code 60.

The portfolio folder 72A may be copied from one storage medium 64 to another. That is, the computer files 24 are stored at a location that is remote to both the student user 20 and the reviewers 30. Typically, both the student user 20 and the reviewers 30 access the portfolio folder 72A using the electronic communication network 10. There may, however, be a need to copy the portfolio folder 72A to another storage medium 64, such as a CD-ROM.

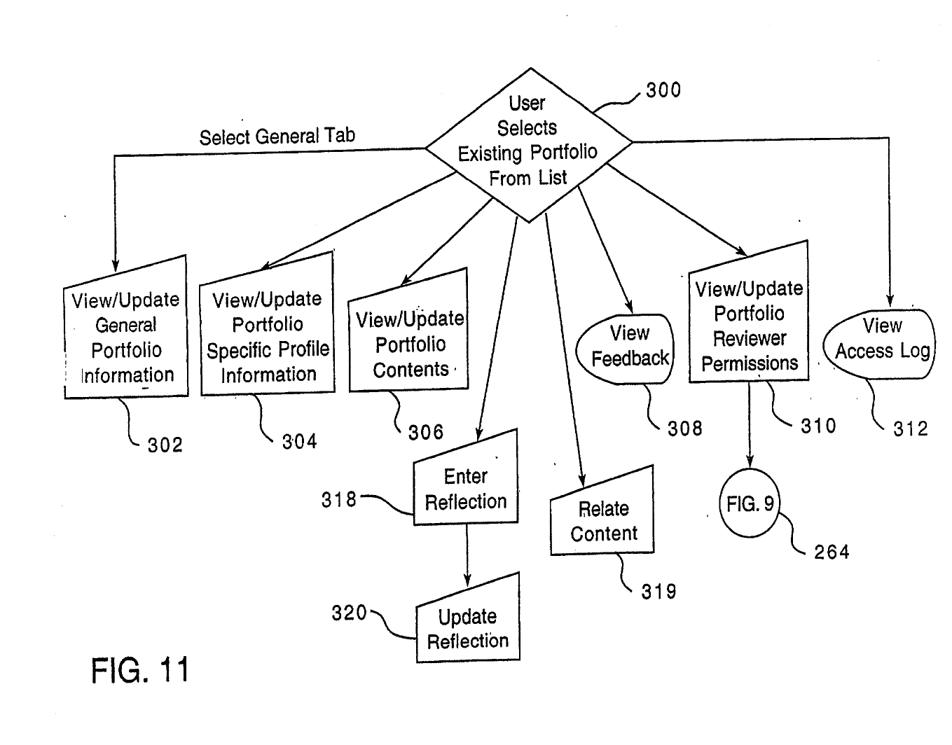

After a portfolio folder 72A is created, the computer executable code 60 allows the student user 20 to edit 254 the portfolio folder 72A. As shown on FIG. 11, when editing 254 a portfolio folder 72A, after selecting the edit portfolio 254 option, the computer executable code 60 allows the student user 20 to select a portfolio 72A to edit 300. The computer executable code 60 then allows the student user 20 to edit the portfolio folder profile 302, edit the profile specific information 304, that is, edit any profile data that is incorporated into the portfolio folder, edit the portfolio content 306, view feedback from feedback reviewers 40, edit the selection of reviewers allowed to view the portfolio folder 310, or view the access log. Functions such as editing the portfolio information 302 are accomplished by editing the information originally input by the student user 20. When editing the selection of reviewers allowed to view the portfolio folder 310, the student user is shown the list of reviewers 30 again and may make new selections by changing the appropriate check box 158. As will be described below, when a feedback reviewer 40 reviews the portfolio, the feedback reviewer 40 is permitted by the computer executable code 60 to leave a feedback report 44. The computer executable code 60 tracks who has accessed the portfolio folder 72A by tracking the user names. The computer executable code 60 allows the student user 20 to view 308 both the feedback report 44 and view a log 312 of who has accessed the portfolio folder 72A.

The student user 20 may also form an association between content elements 270 within a portfolio folder 72A by relating 314 the elements 270. For example, the student user 20 creates 268 a new portfolio folder 72A and adds a goal 280 to write effectively. Later, the student user 20 writes a paper and associates that report with the portfolio folder 72A. After the paper receives a good grade, the student user 20 wishes to use the paper as an example of reaching the goal. The computer executable code 60 allows the student user 20 to relate 314 these two elements to each other. Once the student user 20 has selected the relate content option 314, the computer executable code 60 presents the student user with a list of the content elements 270 in the portfolio folder 72A including the report and the goal. The student user then selects the elements 270 by using an input field 153, e.g. check boxes 158, to be related.

The computer executable code 60 also allows the student user 20 to create their own feedback in the form of a reflection 318. Typically, a reflection would be a text file wherein the student user 20 provides his or her own comments regarding a selected element 270. The computer executable code 60 also allows the student user to edit 320 the reflection.

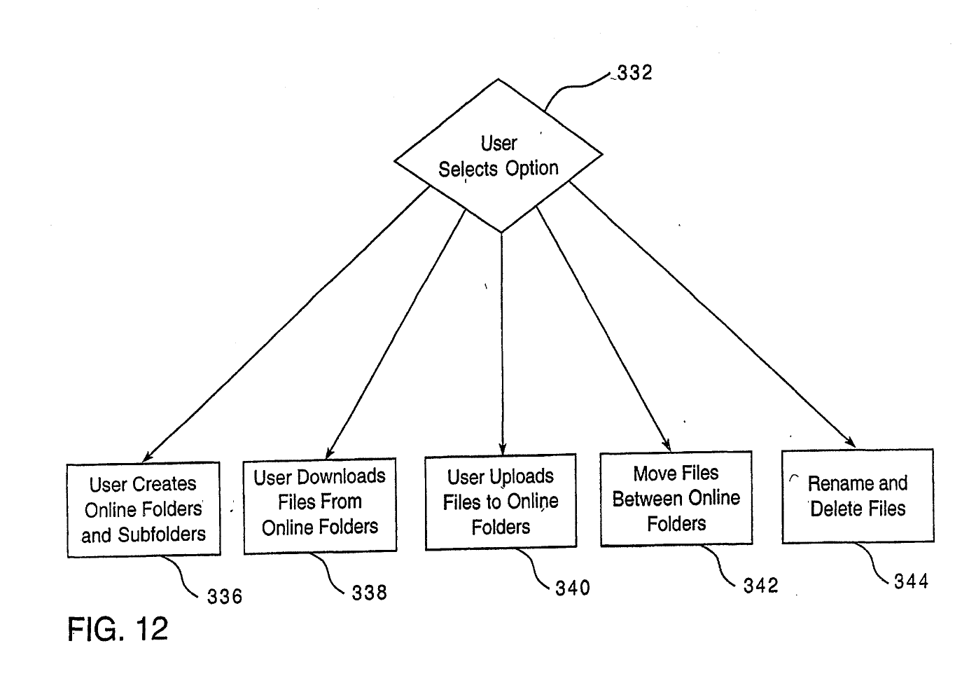

The final option on the first level menu 140, tools 330, is for file management. The computer executable code 60 allows the student user to select the tools 330 before presenting the student user 20 with the second level options of file management 332 and security 334. If the student user selects the file management option 332, (see FIG. 12) the computer executable code 60 allows the student user to create directories 336 in the storage medium 64, download 338 or upload 340 computer files 24, move computer files 24 between directories 342 or rename or delete 344 computer files 24 from the directories. Such file management is well known in the art. The computer executable code 60 also allows the student user 20 to edit the security 334 for various portfolio folders 78A. This option is a shortcut to editing the selection of reviewers allowed to view the portfolio folder 310 as described above.

Alternatively, the computer executable code 60 may be accessed by a reviewer 30. The first time a reviewer 30 accesses the computer executable code 60, the reviewer 30 must also set up an account 204. Groups of reviewers 30 may be affiliated as described above. The computer executable code 60 is structured to store the affiliated reviewers 30 and present the list of reviewers 30 in an organized hierarchy as described above. Once the reviewer 30 has set up an account, the reviewer 30 accesses the computer executable code 60 through the electronic communication network 10. After the reviewer 30 has identified himself as a reviewer 400, the computer executable code 60 allows the reviewer 30 to manage groups 402, query 404 computer executable code 60, or view 406 a portfolio folder 72A that the reviewer has been given permission to view by a student user 20. The step of managing groups 402 is similar to file management as described above. This allows the reviewer to organize the account. The computer executable code 60 also allows the reviewer to submit a query 404 that will cause the computer executable code 60 to search for portfolio folders 72A, 72B, 72C that have data matching the query and to which the reviewer 30 has been granted permission to view. An example of a query is, “locate all students with a major in English and a minor in Japanese.” This information is stored in the tags 25 associated with the portfolio folders 72A, 72B, 72C. The computer executable code 60 then returns the data to the reviewer 408. The reviewer may then further process the data, e.g. by exporting the data to an assessment program.

The computer executable code 60 also allows the reviewer 30 to view 406 all the portfolio folders 72A, 72B, 72C the reviewer 30 has been given permission to review. The computer executable code 60 allows the reviewer 30 to select 410 the portfolio folder 72A to review. The reviewer may then access the various elements the portfolio folder 72A. The elements 270 may be identified by hyperlinks or be listed with an associated input field 153, such as a check box 158. When the reviewer selects the element 270, the computer file 24 for the element 270 is transferred through the electronic communication network 10 to the second computer 42 or third computer 52 being used by the reviewer 30.

If the reviewer is a feedback reviewer 40, the computer executable code 60 allows the feedback reviewer 40 to create 412 a feedback report 44 for the selected portfolio folder 72A or element 270 of the portfolio folder 72A. The feedback report 44 is incorporated into the portfolio folder 72A or element 270 of the portfolio folder 72A. As described above, one example of a feedback reviewer 40 is a teacher commenting on the portfolio folder 72A of a student user 20. Alternatively, a reviewer 30 may be an observer reviewer 50 that may only view a portfolio folder 72A and the elements 270 therein. As described above, one example of an observer reviewer 50 is a potential employer reviewing the work by a student user 20.

The computer executable code 60 also allows a reviewer 30 to provide a template for a portfolio folder 72A. A template provides the structure for the elements 270 of a portfolio folder 72A. These elements are chosen in a similar fashion as described above. However, when the template is complete, the computer executable code 60 stores and indexes the template so that only users with the proper affiliation code may access the template. Continuing the student example from above, a feedback reviewer 40, such as a chemistry laboratory teacher, creates a template for a class which will perform 5 experiments. The template includes an assignment, an activity, an objective, and a standard for each experiment. The feedback reviewer 40 provides the computer files 24 for the objective and the standard. Each student user will write a paper for each assignment and a report on each activity or laboratory experiment. After each experiment, and after the student user has given the teacher reviewer permission to access the portfolio folder 72A, the feedback reviewer 40 accesses the portfolio folder 72A for each student and compares the paper and the report to the stated objective and standard. The teacher reviewer 40 may then write a feedback report 44. The feedback report 44 may then be viewed 308 by the student user 20.

### Example

In operation, and again using the student-teacher-employer example from above, the method works as follows. The computer executable code 60 is operational on the remote server 12. A student user 20, a teacher feedback reviewer 40 and an employer observer reviewer 50 each open an account 204 to use the computer executable code 60. Each student user 20, a teacher feedback reviewer 40 and an employer observer reviewer 50 enter their initial information and are assigned user names and passwords. The student user 20 and the teacher feedback reviewer 40 also enter 234 the affiliation code for the school. Thus, the computer executable code 60 will present the student user 20 with a list of teacher reviewers 40 for the school and any template created by a teacher feedback reviewer 40 will be available to the student user 20.

The teacher feedback reviewer 40 then uses a second computer 42 to access the computer executable code 60 through the electronic communication network 10. The teacher feedback reviewer 40 creates a template to be used by each of her students to record their assignments. The template designed by the teacher feedback reviewer 40 includes a plurality of elements 270 including a final report.

The student user 20 using the first computer 22 accesses the computer executable code 60 through the electronic communication network 10. Initially, the student user 20 has a copy of her resume as a computer file 24 on a floppy disk. The student user 20 accesses the computer executable code 60 and clicks on the tools menu 330, then clicks on the file management option 332, and finally clicks on the create a folder option 336. The computer executable code 60 allows the student user 20 to create an online folder which she names “resume.” The student user 20 again clicks on the tools menu 330, then clicks on the file management option 332, and finally clicks on the file transfer option. At this point the computer executable code 60 allows the student user 20 to upload 340 her resume computer file 24 in to the resume online folder.

During the first day of classes, the teacher feedback reviewer 40 provides each student with the name for the template to be used by students of the teacher feedback reviewer 40. The student user 20 again accesses the computer executable code 60 through the electronic communication network 10. The student user 20 signs in 200 and the computer executable code 60 presents with the first level menu 140. The student user 20 selects the portfolio option 250 and then selects the create new portfolio option 252 on the second level menu 142. The computer executable code 60 then presents the student user 20 with the option of using a template. The student user 20 selects this option 256 and enters the name of the template provided by the teacher feedback reviewer 40. The computer executable code 60 then creates a portfolio folder 72A populated with the plurality of elements 270 that the teacher wishes to review. The computer executable code 60 then allows the student user to give permission 258 to the teacher reviewer to access the portfolio folder 72A. Throughout the rest of the semester the student user 20 completes various assignments for the teacher feedback reviewer 40. Each of these assignments are uploaded 340 through the computer executable code 60 onto a storage medium 64 which can be accessed by the computer executable code 60. Also throughout the semester, the teacher feedback reviewer 40 accesses the computer executable code 60 through the electronic communication network 10 and opens the portfolio folder 72A created by the student user 20. The teacher feedback reviewer 40 reviews the computer files 24 created by the student user 20 and creates feedback 412 for each assignment.

Just before the end of the semester, the teacher feedback reviewer 40 becomes ill and a second teacher feedback reviewer 40A takes over the class. The second teacher feedback reviewer 40A has his own account with the computer executable code 60. As the second teacher feedback reviewer 40A was not initially authorized to access the portfolio folder 72A, the student user 20 again accesses the computer executable code 60 through the electronic communication network 10 and selects the portfolio option 250, then selects the edit portfolio option 254. The student user 20 selects to edit the portfolio folder 72A for the class, and more specifically, selects the option to edit 310 the reviewers allowed to access the portfolio folder 72A. As described above, the computer executable code 60 presents the student user 20 with a list of teacher feedback reviewers 40 for the school and/or department. Each teacher feedback reviewer 40 has a check box 158 adjacent to their name. The student user 20 selects the name of the second teacher feedback reviewer 40A and checks the appropriate check box 158. Thus, the student user 20 selects who may access the portfolio folder 72A. From this point forward, the second teacher feedback reviewer 40A accesses the portfolio folder 72A through the electronic communication network 10. At the end of the semester the student user 20 submits a final report which receives a positive feedback report 44 from the second teacher feedback reviewer 40A.

At the end of the semester, the student user 20 begins to look for a job. Initially, the student user 20 accesses the computer executable code 60 as before. The student user then selects to create a new portfolio folder 252. Rather than using a template, the student user formats 260 the second portfolio folder 72B to include the elements 270 of the final report and the resume. The student user 20 then selects to edit the second portfolio 72B and edits 306 the content thereof by associating her resume and her final report to the second portfolio 72B. Thus, when the employer observer reviewer 50 accesses the computer executable code 60 through the electronic communication network 10, it will be able to view the second portfolio 72B. Additionally, because the feedback report is associated with the report, the observer reviewer 50 will be able to see the positive feedback.

The student user 20 allows employers to access the second portfolio 72B by selecting the reviewers from the global list of reviewers. That is, the student user 20 accesses the computer executable code 60 through the electronic communication network 10 and selects the portfolio option 250, then selects the edit portfolio option 254. The student user 20 selects to edit 300 the second portfolio folder 72B, and more specifically, selects the option to edit 310 the reviewers allowed to access the portfolio folder 72B. As described above, the computer executable code 60 presents the student user 20 with a list global list of observer reviewers 50. This list may be sorted by various methods, e.g., by geographic location or by industry type. Each level in the hierarchy and each individual employer observer reviewer 50 has a check box 158 adjacent to their name. For this example, the employer observer reviewer 50 will be sorted by geographic location, e.g. east coast, heartland, and west coast. The student user 20 selects to allow all employer observer reviewers 50 in the east coast geographic region to have access to the second portfolio folder 72B by checking the appropriate check box 158 associated with the east region. By selecting the regional check box 158, all employer observer reviewers 50 in that region will have access to the second portfolio folder 72B. Thus, the student user 20 selects who may access the portfolio folder 72B.

Once the system 1 is established, the system 1 may be used by additional reviewers 30 such as administrators for a school. Provided that a substantial number of students use the system 1, the school administrators, acting as observer reviewers 50, may compile data regarding the students to assess their academic performance. For example, if all first year English students are required to write an end of term paper, the administrators, working through the computer executable code 60, are able to collect a sampling of the term papers, or all papers, by accessing the student user portfolio folders 72A, provided the student user 20 has given permission to access the portfolios 72A.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1-20. (canceled)

21. A computer readable medium storing computer executable code, said stored code comprising:
a master portfolio including a plurality of user computer files;
a plurality of portfolio folders having selected user computer files from said master portfolio, said portfolio folders being selectively accessible; and
an operating code structured to manage said master portfolio and portfolio folders and to store user selected reviewer permissions associated with said portfolio folders.

22. The computer readable medium storing computer executable code of claim 1 wherein:
said operating code includes a stored file including a list of said reviewers;
said operating code structured to present said list of reviewers to said user; and
said operating code structured to allow said user to select which reviewers have access to each portfolio folder.

23. The computer readable medium storing computer executable code of claim 2 wherein said operating code is structured to allow said user to select which user computer files in said master portfolio are associated with each portfolio folder.

24. A computerized network for creating and providing access to a portfolio folder comprising:
a first computer having a computer executable code operable thereon and a plurality of user computer files stored thereon, said user computer files being a master portfolio stored on said first computer;
a plurality of portfolio folders stored on said first computer, said plurality of portfolio folders being selected user computer files from said master portfolio associated with one or more of said plurality of portfolio folders;
said computer executable code including means for a user to control selective access by others to each said portfolio folder; and
a second computer in electronic communication with said first computer, said second computer accessing said information in a portfolio folder to which said user has permitted access.

25. The computerized network of claim 24 wherein said computer executable code is structured to allow said user to select which user computer files in said master portfolio are associated with each portfolio folder.

26. The computerized network of claim 24 wherein:
said computer executable code includes a stored file including a list of said reviewers;
said computer executable code is structured to present said list of reviewers to said user; and
said computer executable code is structured to allow said user to select which reviewers have access to each portfolio folder.

27. The computerized network of claim 26 wherein said computer executable code is structured to present said list of said reviewers as an expandable hierarchy of choice boxes.

28. The computerized network of claim 26 wherein said computer executable code is structured to allow said user to edit which reviewers have access to each portfolio folder.

29. The computerized network of claim 26 wherein said computer executable code is structured to allow said user to edit each said portfolio folder.

30. The computerized network of claim 26 wherein said computer executable code is structured to allow said reviewer to create a feedback report, said feedback report being incorporated into said portfolio folder to which said user has permitted access.

31. The computerized network of claim 30 wherein said computer executable code is structured to allow said user to view said feedback report.

32. The computerized network of claim 26 wherein said computer executable code is structured to allow said reviewer to create a template for said portfolio folder.

33. The computerized network of claim 26 wherein said computer executable code is structured to allow said user to view a log of who has accessed said portfolio folder to which said user has permitted access.

34. A computer implemented method for sharing personal information through an electronic communication network between a user and one or more reviewers, said method comprising the steps of
providing a first computer having a computer executable code and a plurality of user computer files stored thereon, said user computer files being a master portfolio stored on said first computer, said computer executable code structured to associate selected user computer files to be associated with portfolio folders and to allow selective access to said portfolio folders;
establishing accounts for said users and said reviewers;
allowing said user access to said computer executable code through said electronic communication network;
allowing said user to select which reviewer may access said portfolio folders;
allowing said one or more reviewers access to said computer executable code through said electronic communication network;
providing a second computer in electronic communication with said first computer, said second computer structured to access said information in a portfolio folder to which said user has permitted access; and
allowing said one or more reviewers to view said selected portfolio folders according to said user provided selective access.

35. The computer implemented method of claim 34 wherein said step of allowing said user access to said computer executable code through said electronic communication network includes the steps of:
giving said user access via an electronic communications network to input one or more user computer files into said storage medium to create said master portfolio; and
having said computer executable code tag each said user computer file with an identification means.

36. The computer implemented method of claim 34 wherein said step of allowing said user access to said computer executable code through said electronic communication network includes the steps of:
a) having said computer executable code create an index of each said tagged file in said master portfolio; and
b) allowing said user select individual files from said master portfolio to be associated with a portfolio folder.

37. The computer implemented method of claim 36 wherein said step of allowing said user access to said computer executable code through said electronic communication network includes the step of said computer executable code providing a template for said portfolio folder.

38. The computer implemented method of claim 37 wherein said step of allowing said user access to said computer executable code through said electronic communication network includes the step of allowing said user to create additional portfolio folders by associating selected tagged files with one or more portfolio folders.

39. The computer implemented method of claim 34 wherein said step allowing said one or more reviewers to view a portfolio folder selected by said user includes the further steps of:
allowing said one or more reviewers access said portfolio folder through said electronic communication medium; and
displaying the portfolio folder and associated files to said reviewer.

40. The computer implemented method of claim 34 wherein said step of establishing accounts for said users and said reviewers and said step of allowing said user to determine which reviewer may access said portfolio folders includes the further steps of creating and storing an affiliation between a group of reviewers; and
allowing said user to permit selected individual reviewers and/or affiliated reviewers access to said portfolio folder.
